(19) United States
(12) Patent Application Publication
(10) Pub. No.: US 2009/0130928 A1
(43) Pub. Date: May 21, 2009

(54) Cooling system for a turbocharged marine propulsion device

(75) Inventors: Christopher J. Taylor, Fond Du Lac, WI (US); Timothy S. Reid, Fond du Lac, WI (US); Richard A. Davis, Mequon, WI (US); David J. Belter, Oshkosh, WI (US); Klaus Fuoss, Fond du Lac, WI (US)

Correspondence Address: WILLIAM D. LANYI, MERCURY MARINE, W6250 PIONEER ROAD P.O. BOX 1939, FOND DU LAC, WI, 54936-1939, US

(73) Assignee: Brunswick Corporation

(21) Appl. No.: 11/880,233

(22) Filed: Jul. 20, 2007

(51) Int. Cl. B63H 20/28; F01P 3/20; F02B 33/00

(52) U.S. Cl. 440/88 M; 60/320; 60/599

(57) ABSTRACT

A cooling system for a marine engine having a turbocharger provides for the flow of coolant through heat emitting objects prior to flowing through a coolant jacket of the turbocharger itself. This avoids the potentially disadvantageous circumstance of directing cold water directly from a body of water through the cooling jacket of the turbocharger. Both open loop and closed loop versions of the invention are illustrated and described.

### BACKGROUND OF THE INVENTION

1. Field of the Invention

The present invention relates generally to a marine propulsion device that is provided with a turbocharger and, more particularly, to an outboard motor that provides a cooling system for a turbocharger which maintains a desirable operating temperature of the turbocharger.

2. Description of the Related Art

Turbochargers are well known to those skilled in the art of engine design. They have been used in conjunction with marine engines, both in sterndrive applications and outboard motors.

U.S. Pat. No. 3,998,055, which issued to Bradford et al. on Dec. 21, 1976, describes a turbocharger for marine engines. It includes a dual chamber block interposed between the carburetor and the turbocharger. The block includes a first chamber for receipt of a fuel air mixture and a second chamber separated by a heat transfer wall from the first chamber. The second chamber receives hot water from the cooling system of the engine and effectively directs heat through the heat transfer wall to prevent condensation of fuel from the fuel air mixture in the first chamber. Consequently, it is possible to use a rich air fuel mixture and maintain the mixture in a vaporized state to prevent premature detonation and deterioration of the engine.

U.S. Pat. No. 4,068,612, which issued to Meiners on Jan. 17, 1978, describes a turbocharger housing construction for marine turbochargers and device for turbocharging a marine engine. The turbocharger includes a water jacket which insulates or shields the heated turbocharger from the engine compartment. Preheated water is directed from a water jacket for the exhaust manifold, through the special design turbocharger housing and finally through the exhaust gas duct.

U.S. Pat. No. 4,677,826, which issued to Iwai et al. on Jul. 7, 1987, describes an outboard motor with a turbocharger. The exhaust system for the engine includes devices for insuring that sufficient backpressure is exerted at the exhaust port of one cylinder during the overlap period when its scavenge passages and exhaust ports are both open so as to preclude the discharge of fresh fuel/air mixture to the atmosphere without adversely affecting the turbocharger performance.

U.S. Pat. No. 4,630,446, which issued to Iwai et al. on Dec. 23, 1986, describes an outboard motor with a turbocharger. The exhaust system for the engine includes devices for insuring that sufficient backpressure is exerted at the exhaust port of one cylinder during the overlap. When its scavenge passages and exhaust ports are both open so as to preclude the discharge of fresh fuel/air mixture to the atmosphere without adversely affecting the turbocharger performance. A valve arrangement is controlled for controlling the proportion of the exhaust gases that flow across the turbocharger so that at some running conditions the turbocharger receives all of the exhaust gases. An expansion chamber device is incorporated in the driveshaft housing of the outboard motor and in some embodiments, the turbocharger turbine inlet receives its gases from the expansion chamber.

U.S. Pat. No. 4,741,162, which issued to Torigai on May 3, 1988, describes an engine with a turbocharger for an outboard motor. Turbochargers are driven by exhaust gases flowing through an exhaust manifold on one side of the engine and deliver a compressed charge to an intercooler that extends across the top of the engine. The intercooler discharges to an induction system that is disposed on the side of the engine opposite to the exhaust manifold side.

U.S. Pat. No. 4,827,722, which issued to Torigai on May 9, 1989, describes an engine with a turbocharger for an outboard motor. The engine is provided with a plurality of carburetors that draw air through a common plenum chamber. The turbochargers deliver pressurized air to the plenum chamber and an intercooler is formed in the plenum chamber by having a heat exchanger extending across the plenum chamber. The intercooler is cooled by circulating engine coolant through it.

U.S. Pat. No. 6,659,089, which issued to Gokan et al. on Dec. 9, 2003, describes a turbocharger arrangement structure for a personal watercraft. A hull and a deck of a personal watercraft are formed watertight and an opening of the deck is closed with a seat to form a body internal space. An engine and a turbocharger are connected to an exhaust manifold of the engine and are provided in the space and the turbocharger is disposed higher than a body internal opening of the intake duct. A water jacket is formed in a casing of a turbine portion of the turbocharger and an exhaust jacket is formed in a bearing casing of the turbocharger and cooling water is supplied to the water jacket and cooling oil is supplied to the oil jacket. The cooling water to the water jacket is supplied by a different turbocharger cooling water passage independent of any other cooling water passage.

U.S. patent application Ser. No. 10/626,926, which was filed by Wizgall et al. on Jul. 25, 2003, describes a cooling system for a turbocharged internal combustion engine. A turbine casing for a turbocharged internal combustion engine for marine applications is a single piece formed with the turbine casing and a cooling facility surrounds both the turbine casing as well as the exhaust manifold. The cooling facility is a hollow space, formed by the double wall that can be filled with coolant, whereby the coolant preferably is ocean/lake water. A separate cooling circuit for the cooling facility of the combined turbine casing and exhaust manifold is provided for the cooling of a bearing housing, which is used to support a turbine bearing.

The patents described above are hereby expressly incorporated by reference in the description of the present invention.

Since outboard engines use cooling water obtained from a body of water in which the marine propulsion device is operated, it is possible for very cold water to be drawn into the engine for cooling purposes. These cold temperatures could create an undesirable situation for turbocharger exhaust scroll cooling. These undesirable situations relate to the presence of large thermal gradients in the system and excessive heat removal from the exhaust gas, particularly prior to the passage of the exhaust gas through the turbine portion of the turbocharger. In addition, in four stroke outboard engines, the use of very cold water can result in oil dilution, by fuel, and poor fuel preparation that can result in poor fuel economy. Closed loop engine cooling systems can work to ameliorate some of these disadvantages.

It would therefore be significantly beneficial if the turbocharger can be cooled, as part of an overall cooling system for the marine propulsion device, in such a way that the energy provided by the exhaust gas flow to the turbocharger is not significantly decreased by the cooling system. In other words, it would be significantly beneficial if the turbocharger could be cooled, but in a way that does not overcool the exhaust gas flowing to and through the turbocharger. Although it is necessary to remove excessive heat from the turbocharger, it would be beneficial if the amount of heat removed from the exhaust gas flowing to and through the turbocharger could be limited in order to avoid decreasing the overall energy provided to the turbocharger by the flow of exhaust gas.

### SUMMARY OF THE INVENTION

A turbocharged outboard motor, made in accordance with a preferred embodiment of the present invention, comprises an engine having a heat emitting component, a turbocharger connected to an exhaust conduit of the engine to receive a stream of exhaust gas from the engine, a coolant jacket disposed in thermal communication with a housing structure of the turbocharger, and a pump connected in fluid communication with a coolant jacket and configured to cause a coolant to flow through the coolant jacket in thermal communication with the turbocharger and to flow in thermal communication with the heat emitting component.

In one embodiment of the present invention, the coolant is directed to flow in thermal communication with and receive heat from the heat emitting component prior to flowing through the coolant jacket of the turbocharger. The heat emitting component can be a cylinder head of the engine or an exhaust manifold of the engine. In addition, the heat emitting component can be an exhaust conduit of the engine or a cylinder block of the engine. In certain embodiments of the present invention, the heat emitting component is an oil cooler of the engine.

In certain embodiments of the present invention, the coolant is water which is drawn by a pump from a body of water in which the outboard motor is operated. In certain embodiments of the present invention, a heat exchanger is provided and connected in fluid communication with the heat emitting component, the coolant jacket and the pump in a closed engine cooling system. The pump can be a circulation pump.

### BRIEF DESCRIPTION OF THE DRAWINGS

The present invention will be more fully and completely understood from a reading of the description of the preferred embodiment in conjunction with the drawings, in which:

FIG. 1 shows one embodiment of the present invention;

FIG. 2 shows a second embodiment of the present invention;

FIG. 3 shows a third embodiment of the present invention;

FIGS. 4-7 show various alterations that can be provided within the various embodiments of the present invention; and

FIG. 8 is a graphical representation of the change of temperature of a coolant as it flows through the marine propulsion system.

### DESCRIPTION OF THE PREFERRED EMBODIMENT

Throughout the description of the preferred embodiment of the present invention, like components will be identified by like reference numerals.

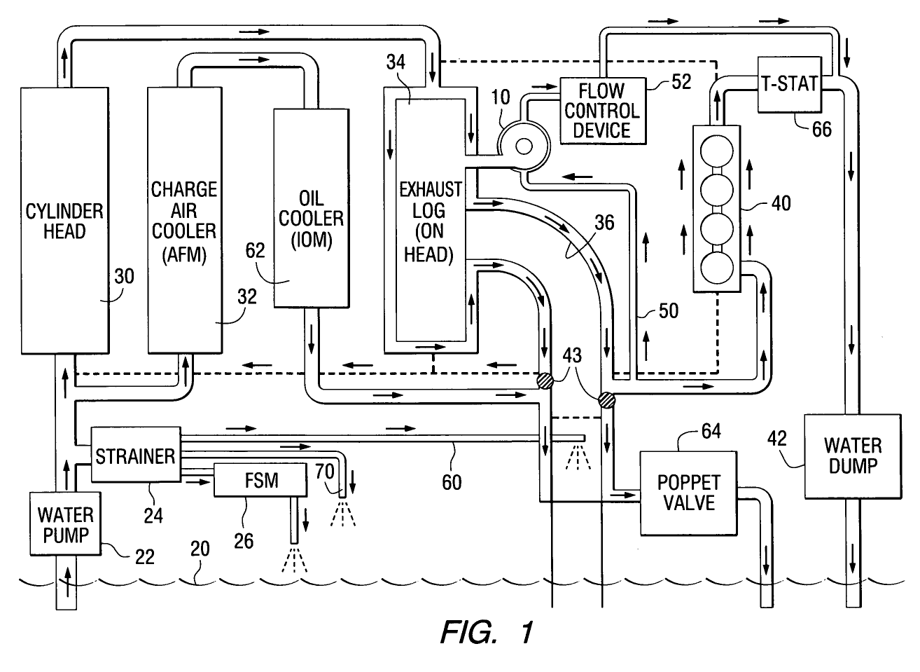

FIG. 1 is a schematic representation of a marine propulsion device, such as an outboard motor, which includes a turbocharger 10. The illustration in FIG. 1 is intentionally shown in a highly schematic fashion in order to describe the sequence and path of cooling water as it flows through the various heat emitting components of the system. Water is pumped from a body of water 20 by a water pump 22. Some of the water from the water pump 22 is directed through a strainer 24 and flows through a fuel system module 26. A significant portion of the water flowing from the water pump 22 is directed to the cylinder head 30 of the engine and a charge air cooler 32. The water flowing through the cylinder head 30 then passes to the exhaust manifold 34 which is sometimes referred to by those skilled in the art as the exhaust log. In the example shown in FIG. 1, the exhaust manifold is formed as an integral part of the cylinder head. After passing through the cooling jacket of the exhaust manifold 34, the water is shown flowing through a cooling jacket of an exhaust pipe 36. Then, the water is directed to flow through the cylinder block 40 from which it is caused to flow overboard through the region identified as the water dump 42. This water is returned to the body of water 20. A portion of this water flows through an orifice formed by water dams 43 and is in fluid communication with the poppet valve 64. Between the exhaust pipe 36 and the cylinder block 40, some of the cooling water is directed through conduit 50 to the turbocharger 10. A flow control device 52 regulates the flow of water through the cooling jacket of the turbocharger 10. This flow control device will be described in greater detail below.

With continued reference to FIG. 1, some of the water passing through the strainer 24 can be directed, through conduit 60, to the flow of exhaust gas through the exhaust pipe 36. In addition, some of the water flowing through the oil cooler 62, which is downstream from the charge air cooler 32, is directed to a water jacket of the exhaust pipe 36. The flow of this water is controlled by a poppet valve 64 which is responsive to water pressure within the system. A thermostat 66 controls the flow of water through the cylinder block 40 of the engine. A telltale 70 is also provided. In a manner that is generally well known to those skilled in the art, exhaust gas is provided from the exhaust manifold 34 to the turbine portion of the turbocharger 10. The water provided, through conduit 50, to the housing of the turbocharger 10 has already passed through the cylinder head 30, the exhaust manifold 34, and the exhaust pipe 36 prior to being directed to the cooling jacket of the turbocharger 10. As a result, the configuration shown in FIG. 1 decreases the likelihood that very cold water will be directed to the turbocharger 10. This use of cold water can be disadvantageous because it can significantly decrease the energy provided to the turbocharger 10 by the energy stored in the exhaust gas.

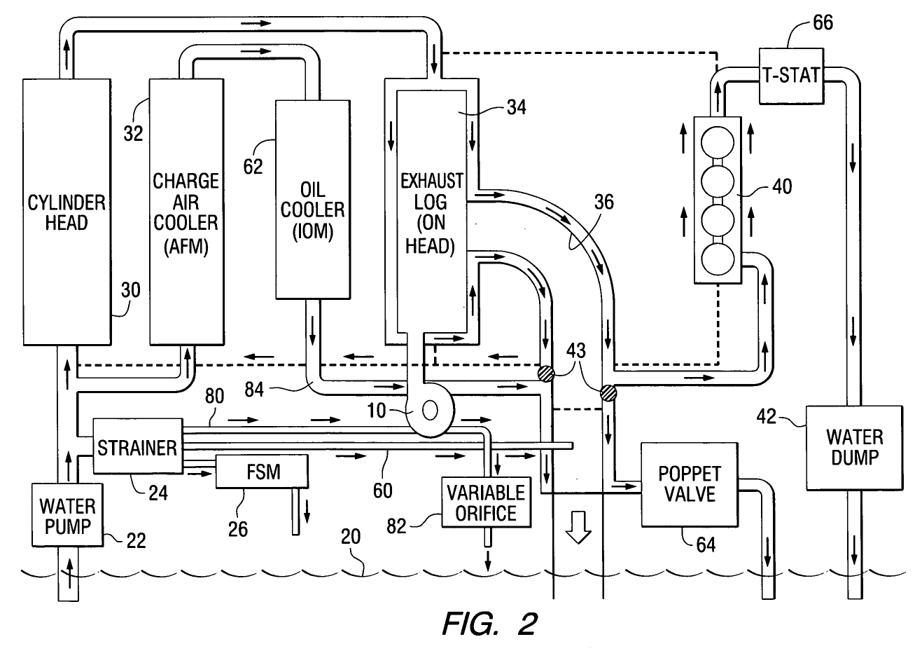

FIG. 2 is generally similar to the system shown in FIG. 1, but with modifications made to the cooling circuit that affects the turbocharger 10. In FIG. 2, some of the water flowing through the strainer 24 is directed to the turbocharger 10, through conduit 80. A variable orifice 82 is used to regulate the flow of water through conduit 80 and through the cooling jacket of the turbocharger 10. The rate of flow through conduit 80 is controlled by the variable orifice 82 to be sufficiently slow to avoid overcooling the exhaust gas.

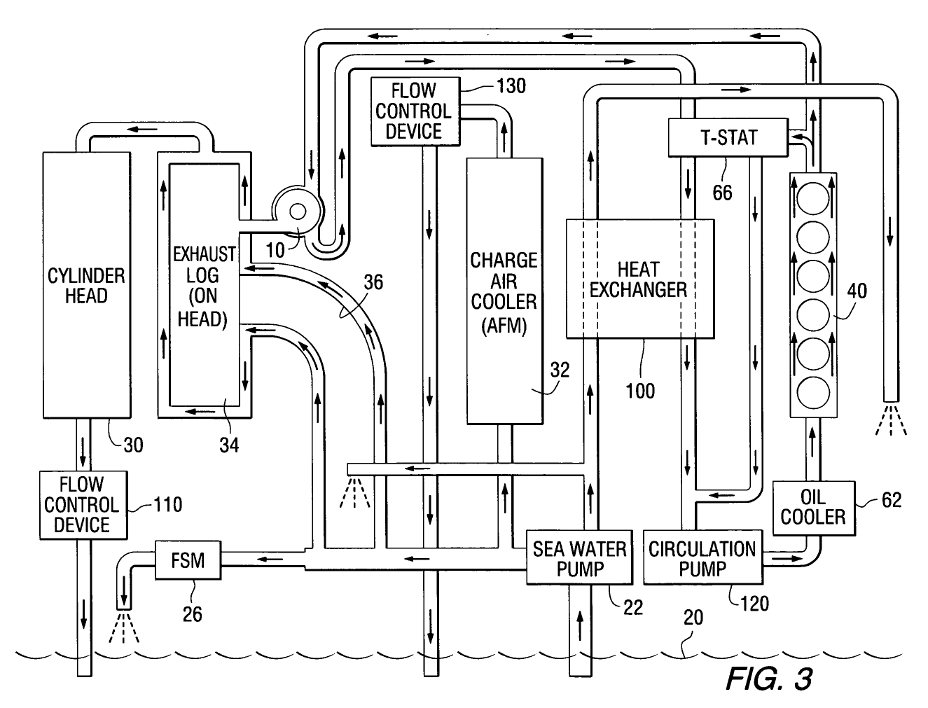

FIG. 3 shows an embodiment of the present invention which is incorporated as a portion of a closed cooling system. As those skilled in the art of marine propulsion systems are aware, closed marine cooling systems most typically are combinations of closed cooling systems and open cooling systems. In other words, components of the engine and its accessories can be cooled with a coolant in a closed portion of the system and that coolant can be cooled, with a heat exchanger 100, by water pumped from the body of water 20.

In FIG. 3, water is pumped by the seawater pump 22 to the heat exchanger 100. The pump 22 also provides a flow of water from the body of water 20 to the charge air cooler 32 and to the exhaust pipe 36, the exhaust manifold 34, and the cylinder head 30. This flow of water is controlled by a flow control device, such as a poppet valve 110. The closed portion of the cooling system shown in FIG. 3 circulates a coolant, such as an ethylene glycol mixture, by a circulation pump 120. After flowing through the heat exchanger and having heat removed from the closed circuit coolant, the circulation pump 120 causes the coolant to flow through the oil cooler 62 and the cylinder block 40. From there, the coolant flows to the turbocharger 10 and then back to the heat exchanger 100. A thermostat 66 controls the flow of coolant from the cylinder block 40 to the heat exchanger 100. The other components shown in FIG. 3, such as the flow control device identified as a poppet valve 130, perform functions similar to similar components described above.

With reference to FIGS. 1 and 3, it can be seen that one of the characteristics of the illustrated embodiments of the present invention is that coolant is circulated through heat emitting components prior to being circulated through the water jacket of the turbocharger 10. This is true in the open cooling systems of FIGS. 1 and 2 and the closed cooling system of FIG. 3.

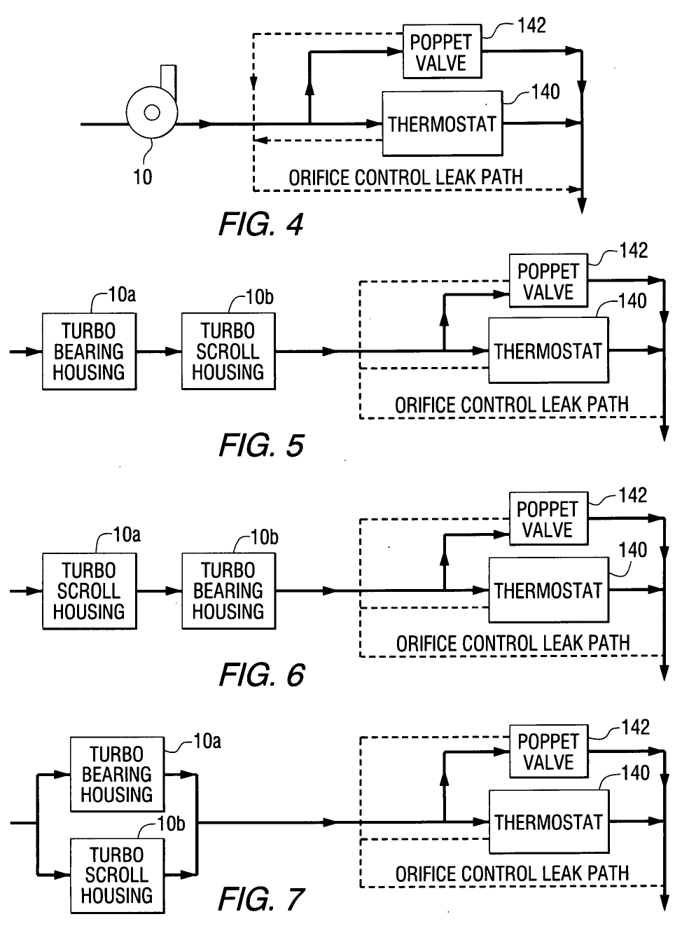

FIG. 4 is a partial schematic of a cooling system which is intended to illustrate one alternative embodiment of the present invention. After flowing through the cooling jacket of the turbocharger 10, the coolant is directed in parallel paths through a thermostat 140 and a poppet valve 142. The dashed lines in FIG. 4 represent an orifice control leak path. In the fluid circuit shown in FIG. 4, either elevated temperature or elevated pressure can cause coolant to flow through the cooling jacket of the turbocharger 10.

FIG. 5 shows an alternative embodiment of the present invention in which the coolant is caused to flow sequentially through the turbocharger bearing housing 10A and the turbocharger scroll housing 10B prior to being directed to the thermostat and poppet valve, 140 and 142.

In FIG. 6, the coolant flow passes through the turbocharger bearing housing and turbocharger scroll housing, 10A and 10B, in reverse order as that described above in conjunction with FIG. 5.

In FIG. 7, water is directed to flow in parallel through both the turbocharger bearing housing 10A and turbocharger scroll housing 10B. It should be understood that the alternative configurations shown in FIG. 4-7 represent various choices of how the coolant can be caused to flow through the turbocharger 10 and beyond.

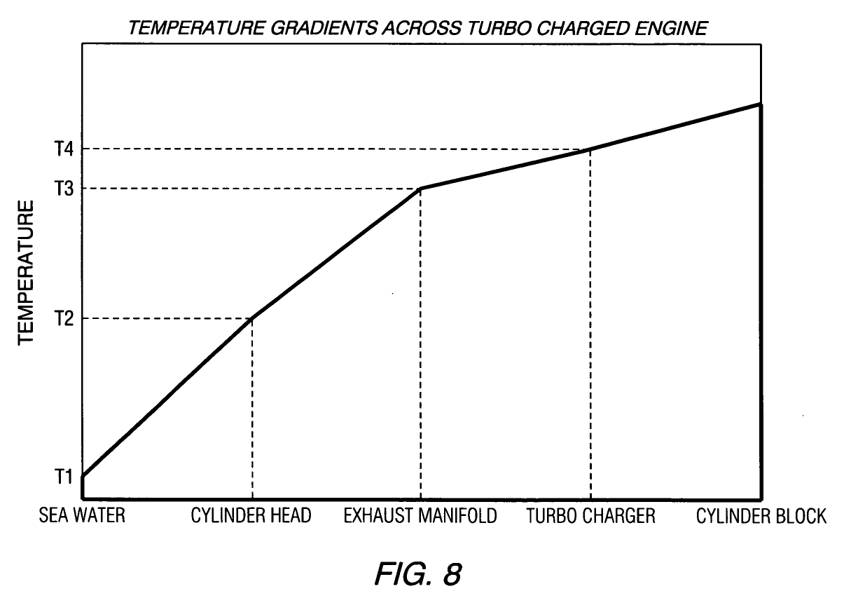

FIG. 8 is a highly schematic graphical representation of the typical change in coolant temperature as it flows through the cooling system of a marine propulsion device. Seawater, at temperature T1, is heated as it flows through the cylinder head to an elevated temperature T2. After passing through the exhaust manifold, the temperature of the coolant is further increased to temperature T3. When it enters the turbocharger, the temperature is significantly above the temperature T1 of the seawater. As a result, the arrangements described above in conjunction with FIGS. 1 and 3 avoid the introduction of cold water, such as the temperature T1 of seawater, into the cooling jacket of the turbocharger and, as a result, avoids overcooling of the exhaust gases entering the turbocharger. In addition, it avoids potential condensation within the various cavities and conduits of the turbocharger.

With reference to FIGS. 1-8, it can be seen that a turbocharged outboard motor made in accordance with one of the various embodiments of the present invention, comprises an engine having a cylinder head 30 and a cylinder block 40. The engine has at least one heat emitting component. A turbocharger 10 is provided and connected to an exhaust conduit, such as the exhaust manifold 34. It receives a stream of exhaust gas from the engine. A coolant jacket is disposed in thermal communication with a housing structure of the turbocharger 10. A pump, such as the water pump 22, is connected in fluid communication with the cooling jacket of the turbocharger 10 and configured to cause a coolant to flow through the coolant jacket in thermal communication with the turbocharger 10 and to flow in thermal communication with the heat emitting component. In the embodiment shown in FIG. 3, the pump is the circulation pump 120 which causes the coolant to flow through the closed loop portion of the system shown in FIG. 3.

Although the present invention has been described in particular detail and illustrated to show several embodiments, it should be understood that alternative embodiments are also within its scope.

1. A turbocharged outboard motor, comprising:
an engine having a heat emitting component;
a turbocharger connected to an exhaust conduit of said engine to receive a stream of exhaust gas from said engine;
a coolant jacket disposed in thermal communication with a housing structure of said turbocharger; and
a pump, connected in fluid communication with said coolant jacket, configured to cause a coolant to flow through said coolant jacket in thermal communication with said turbocharger and to flow in thermal communication with said heat emitting component.

2. The outboard motor of claim 1, wherein:
said coolant is directed to flow in thermal communication with and receive heat from said heat emitting component prior to flowing through said coolant jacket of said turbocharger.

3. The outboard motor of claim 1, wherein:
said heat emitting component is a cylinder head of said engine.

4. The outboard motor of claim 1, wherein:
said heat emitting component is an exhaust manifold of said engine.

5. The outboard motor of claim 1, wherein:
said heat emitting component is said exhaust conduit of said engine.

6. The outboard motor of claim 1, wherein:
said heat emitting component is a cylinder block of said engine.

7. The outboard motor of claim 1, wherein:
said heat emitting component is an oil cooler of said engine.

8. The outboard motor of claim 1, wherein:
said coolant is water drawn by said pump from a body of water in which said outboard motor is operated.

9. The outboard motor of claim 1, further comprising:
a heat exchanger connected in fluid communication with said heat emitting component, said coolant jacket and said pump in a closed cooling system, said pump being a circulation pump.

10. A turbocharged outboard motor, comprising:
an engine having a heat emitting component;
a turbocharger connected to an exhaust conduit of said engine to receive a stream of exhaust gas from said engine;
a coolant jacket disposed in thermal communication with a housing structure of said turbocharger; and
a pump, connected in fluid communication with said coolant jacket, configured to cause a coolant to flow through said coolant jacket in thermal communication with said turbocharger and to flow in thermal communication with said heat emitting component, said coolant being water drawn by said pump from a body of water in which said outboard motor is operated.

11. The outboard motor of claim 10, wherein:
said coolant is directed to flow in thermal communication with and receive heat from said heat emitting component prior to flowing through said coolant jacket of said turbocharger.

12. The outboard motor of claim 11, wherein:
said heat emitting component comprises a cylinder head of said engine.

13. The outboard motor of claim 12, wherein:
said heat emitting component comprises an exhaust manifold of said engine.

14. The outboard motor of claim 13, wherein:
said heat emitting component comprises said exhaust conduit of said engine.

15. A turbocharged outboard motor, comprising:
an engine having a heat emitting component;
a turbocharger connected to an exhaust conduit of said engine to receive a stream of exhaust gas from said engine;
a coolant jacket disposed in thermal communication with a housing structure of said turbocharger;
a pump, connected in fluid communication with said coolant jacket, configured to cause a coolant to flow through said coolant jacket in thermal communication with said turbocharger and to flow in thermal communication with said heat emitting component; and
a heat exchanger connected in fluid communication with said heat emitting component, said coolant jacket, and said pump in a closed cooling system, said pump being a circulation pump.

16. The outboard motor of claim 15, wherein:
said coolant is directed to flow in thermal communication with and receive heat from said heat emitting component prior to flowing through said coolant jacket of said turbocharger.

17. The outboard motor of claim 16, wherein:
said heat emitting component comprises a cylinder block of said engine.

18. The outboard motor of claim 17, wherein:
said heat emitting component comprises an oil cooler of said engine.
